(19) United States
(12) Patent Application Publication
(10) Pub. No.: US 2026/0145868 A1
(43) Pub. Date: May 28, 2026

(54) EV RECOVERY POD SYSTEM AND METHOD

(71) Applicant: Ronald M. Butler, West Bloomfield, MI (US)

(72) Inventor: Ronald M. Butler, West Bloomfield, MI (US)

(21) Appl. No.: 19/401,543

(22) Filed: Nov. 26, 2025

Related U.S. Application Data
(60) Provisional application No. 63/725,733, filed on Nov. 27, 2024.

(51) Int. Cl. B65D 90/22; A62C 3/07; A62C 37/40; B65D 90/00; B65D 90/04

(52) U.S. Cl. CPC B65D 90/22; A62C 3/07; A62C 37/40; B65D 90/0066; B65D 90/041

(57) ABSTRACT

Ways for containing a vehicle and monitoring for a thermal event are provided that can include a container, a detection module, an actuator, and a controller. The container can include a main body, an interior volume to receive the vehicle, an opening for ingress and egress of the vehicle with a selectively sealable closure, a temperature resistant material, and a fire suppression system. The detection module detects the thermal event and generates an alert. The actuator seals the opening of the container with the selectively sealable closure. The controller communicates with the detection module and the actuator, receives the alert from the detection module, activates the actuator to seal the opening of the container, and activates the fire suppression system. The system enables safe containment and monitoring of vehicles experiencing thermal events through automated detection, sealing, and alerts integrated within a temperature resistant container structure.

### CROSS-REFERENCE TO RELATED APPLICATIONS

This application claims the benefit of U.S. Provisional Application No. 63/725,733, filed on Nov. 27, 2024. The entire disclosure of the above application is incorporated herein by reference.

### FIELD

The present technology relates to safety containment systems for vehicles, and, more particularly, to recovery systems for containing and monitoring electric vehicles experiencing battery-related thermal events.

### INTRODUCTION

This section provides background information related to the present disclosure which is not necessarily prior art.

Electric vehicles that include battery systems can be subject to thermal events during battery failures, presenting unique safety challenges. Thermal events can involve thermal runaway conditions where battery cells experience uncontrolled temperature increases that can lead to fires, toxic gas emissions, and other hazardous conditions. For example, lithium-ion batteries commonly used in electric vehicles can undergo chemical reactions during thermal events that can produce dangerous gases and sustained heat output. These conditions can pose risks to an emergency responder, vehicle owner, or transportation personnel, and to the surrounding area where the affected vehicle is located.

Certain methods for handling electric vehicles experiencing or at risk of a thermal event can be inadequate for containment and processing. A damaged or compromised electric vehicle can require specialized handling that differs from internal combustion vehicle recovery procedures. The unique characteristics of battery-related thermal events can make it difficult to approach, secure, and transport affected vehicles using conventional equipment. Certain containment solutions can lack integrated systems for monitoring thermal conditions within the containment space. Without automated detection capabilities, personnel can need to manually assess whether a vehicle can be safely handled or transported, which can expose individuals to unnecessary risk.

Transportation of compromised electric vehicles can present challenges that certain conventional containers and transport systems cannot adequately address. When electric vehicles need to be moved following accidents, fires, or other damage, the risk of thermal events during transport can create liability concerns for towing companies and transportation providers. Certain towing services can refuse to transport damaged electric vehicles due to concerns that thermal events could occur while the vehicle is in transit, potentially damaging the tow truck or creating a roadway hazard. The lack of integrated fire suppression and containment features in certain transport containers can leave compromised vehicles insufficiently secured when being moved to recovery or processing facilities.

Real-world scenarios have demonstrated the limitations of certain approaches to handling damaged electric vehicles. For example, during wildfire events in California, electric vehicles that were damaged or burned presented challenges for emergency response personnel. Fire departments encountering a damaged electric vehicle that was experiencing a thermal event were reluctant to approach the vehicle due to safety concerns. In certain cases, an emergency responder can only clear areas around the affected vehicle and establish a perimeter to keep people away, rather than being able to contain and remove the vehicle. The inability to safely secure and transport such vehicles can result in prolonged road closures, extended evacuation periods, and continued risk to surrounding areas.

Certain containment solutions can lack communication and alert capabilities for notifying relevant parties when a thermal event is detected. Without wireless communication systems integrated into a containment structure, information about the status of a contained vehicle is not readily available, e.g., available to an emergency responder, a facility operator, or a remote monitoring center. The absence of global positioning system (GPS) tracking in certain containment systems can make it difficult to monitor the location of compromised vehicles during transport. Certain solutions can also lack an automated alert system that can provide visual and/or audio warnings when a thermal condition exceeds a safe threshold, requiring personnel to conduct a manual inspection that can expose them to hazardous conditions.

Recycling and dismantling of an electric vehicle following a thermal event or battery failure can require facilities and equipment to handle the unique risks associated with battery systems. Vehicle recycling facilities and processing centers can have inadequate containment systems for receiving and storing electric vehicles that can be at risk of thermal events. Without temperature-resistant containment structures and integrated fire suppression capabilities, facilities can be unable to safely process compromised electric vehicles. In other words, processing operations can lack the ability to monitor multiple contained vehicles simultaneously or to respond automatically to thermal events that can develop after vehicles have been placed in storage or processing areas.

There is a continuing need for enhanced containment and processing systems for an electric vehicle experiencing or at risk of a thermal event. Desirably, such systems would integrate automated detection, monitoring, sealing, and communication capabilities within a containment structure suitable for receiving and transporting an electric vehicle, managing a toxic gas produced during the thermal event, and employing temperature-resistant materials to protect against thermal events. Additionally, such systems would allow emergency responders and transportation providers to safely handle a compromised electric vehicle without requiring manual intervention that could expose personnel to hazardous conditions and facilitate the safe transport of an affected vehicle to appropriate recovery and processing facilities while providing remote monitoring and automated alert capabilities to relevant parties.

### SUMMARY

In concordance with the instant disclosure, enhanced containment and processing systems for an electric vehicle experiencing or at risk of a thermal event, have surprisingly been discovered.

The present technology includes ways of containing a vehicle and monitoring for a thermal event. The present technology improves upon certain approaches to handling electric vehicles experiencing or at risk of thermal events by integrating automated detection, monitoring, containment, and response capabilities within a single container system. For example, safety for emergency responders and transportation personnel can be enhanced through temperature resistant materials, automated sealing mechanisms, and fire suppression systems that eliminate the need for personnel to manually approach compromised vehicles. The present technology can provide towing and transportation of damaged electric vehicles to address concerns previously causing transportation providers to refuse such vehicles. The present technology can include wireless communication and global positioning system (GPS) tracking capabilities can enable remote monitoring and automated alert transmission to an emergency responder and a remote monitoring center. Fire suppression systems specifically adapted for battery-related thermal events and evacuation systems for filtering and removing a toxic gas can be incorporated within the container structure. Through these integrated features, the present technology can allow for safe transport of compromised vehicles to recovery and processing facilities while providing continuous monitoring and automated responses to thermal events that can develop during containment or transport.

In certain embodiments, a system for containing a vehicle and monitoring a thermal event is provided. The system can include a container. The container can include a main body, an interior volume to receive the vehicle, an opening for ingress and egress of the vehicle, a temperature resistant material, and fire suppression system. The opening can include a selectively sealable closure. The system can include a detection module to detect the thermal event and generate an alert when the thermal event is detected. The system can include an actuator to seal the opening of the container with the selectively sealable closure. The system can include a controller in communication with the detection module and the actuator. The controller can receive the alert from the detection module and activate the actuator to seal the opening of the container.

In certain embodiments, a device is provided. The device can include a main body, an interior volume to receive the vehicle, an opening for ingress and egress of the vehicle, a temperature resistant material, and a fire suppression system. The opening can include a selectively sealable closure. The device can include a detection module to detect a thermal event and generate an alert when the thermal event is detected. The device can include an actuator to seal the opening of the container with the selectively sealable closure. The device can include a controller in communication with the detection module and the actuator. The controller can receive the alert from the detection module and activate the actuator to seal the opening of the container.

In certain embodiments, a method for containing a vehicle during and monitoring for a thermal event is provided. The method can include a step of providing a system that includes a container. The container can include a main body, an interior volume to receive the vehicle, an opening for ingress and egress of the vehicle, a temperature resistant material, and a fire suppression system. The opening can include a selectively sealable closure. The system can include a detection module to detect the thermal event and generate an alert when the thermal event is detected. The system can include an actuator to seal the opening of the container with the selectively sealable closure. The system can include a controller in communication with the detection module and the actuator. The controller can receive the alert from the detection module and activate the actuator to seal the opening of the container. The method can include a step of receiving, by the controller, the alert generated by the detection module when the thermal event is detected. The method can include a step of activating, by the controller, the actuator to seal the opening of the container with the selectively sealable closure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram illustrating aspects of a system for containing a vehicle and monitoring for a thermal event;

FIG. 2 is a block diagram illustrating further aspects of a system for containing a vehicle and monitoring for a thermal event;

FIG. 3 is a block diagram illustrating additional aspects of a system for containing a vehicle and monitoring for a thermal event;

FIG. 4 illustrates a system for containing a vehicle and monitoring for a thermal event, including a container, a vehicle, and a towing vehicle;

FIG. 5 illustrates a system for containing a vehicle and monitoring for a thermal event, including a container, a vehicle, and a towing vehicle;

FIG. 6 illustrates a vehicle entering a container by use of a winch;

FIG. 7 illustrates a lift on a trailer bed of a towing vehicle;

FIG. 8 illustrates a winch on a trailer bed of a towing vehicle;

FIG. 9 illustrates a container with a vehicle, the container on a trailer bed of a towing vehicle;

FIG. 10 illustrates a vehicle entering a container by use of a winch;

FIG. 11 provides a flowchart illustrating an embodiment of a method for containing a vehicle during and monitoring for a thermal event;

FIG. 12 provides a flowchart extending from FIG. 11 and further illustrates a method for containing a vehicle during and monitoring for a thermal event;

FIG. 13 provides a flowchart extending from FIG. 11 and further illustrates a method for containing a vehicle during and monitoring for a thermal event;

FIG. 14 provides a flowchart extending from FIG. 11 and further illustrates a method for containing a vehicle during and monitoring for a thermal event;

FIG. 15 provides a flowchart extending from FIG. 11 and further illustrates a method for containing a vehicle during and monitoring for a thermal event;

FIG. 16 provides a flowchart extending from FIG. 11 and further illustrates a method for containing a vehicle during and monitoring for a thermal event;

FIG. 17 provides a flowchart extending from FIG. 11 and further illustrates a method for containing a vehicle during and monitoring for a thermal event;

FIG. 18 provides a flowchart extending from FIG. 17 and further illustrates a method for containing a vehicle during and monitoring for a thermal event; and

FIG. 19 provides a flowchart extending from FIG. 11 and further illustrates a method for containing a vehicle during and monitoring for a thermal event.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

All documents, including patents, patent applications, and scientific literature cited in this detailed description are incorporated herein by reference, unless otherwise expressly indicated. Where any conflict or ambiguity can exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that can be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it can be directly on, engaged, connected or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed contents.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

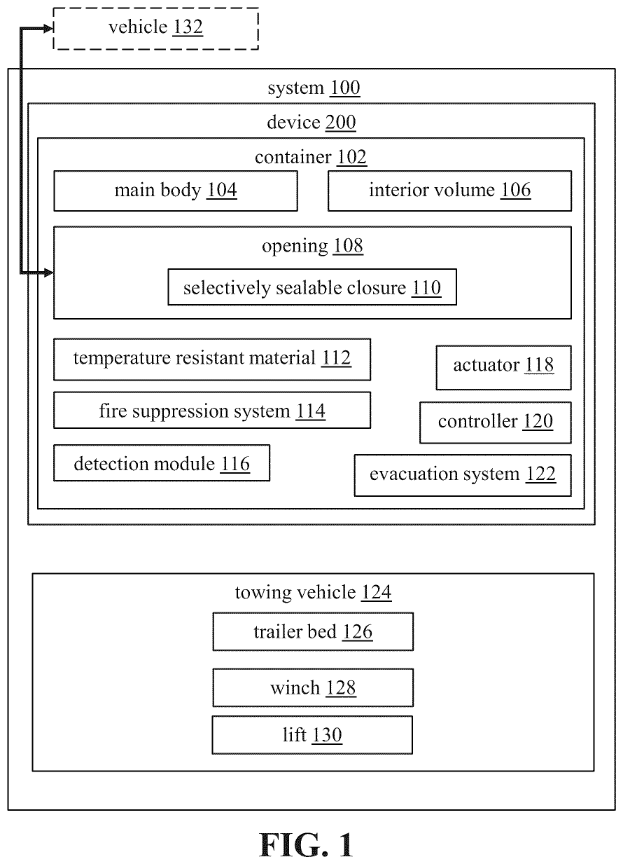

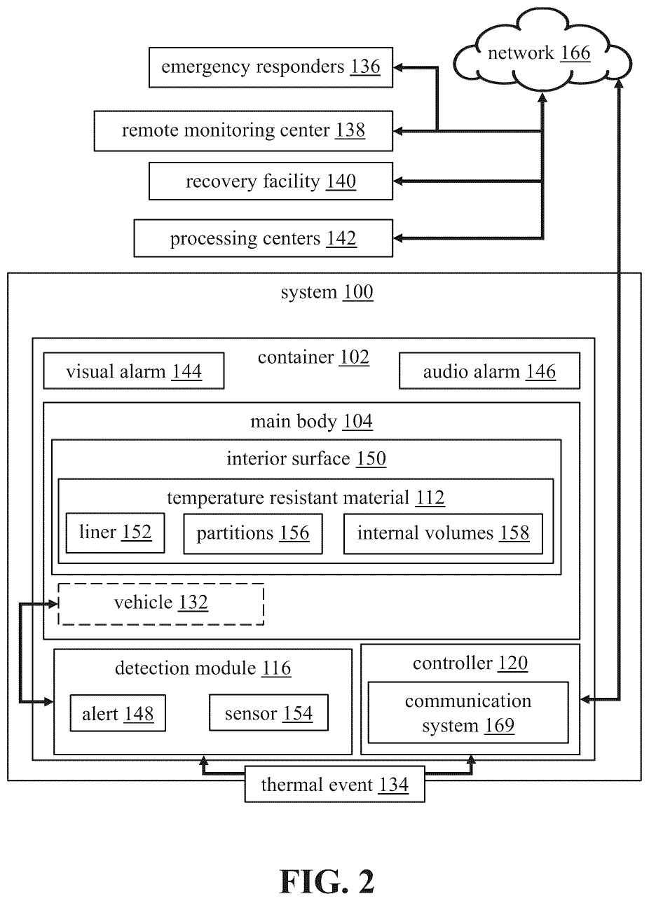

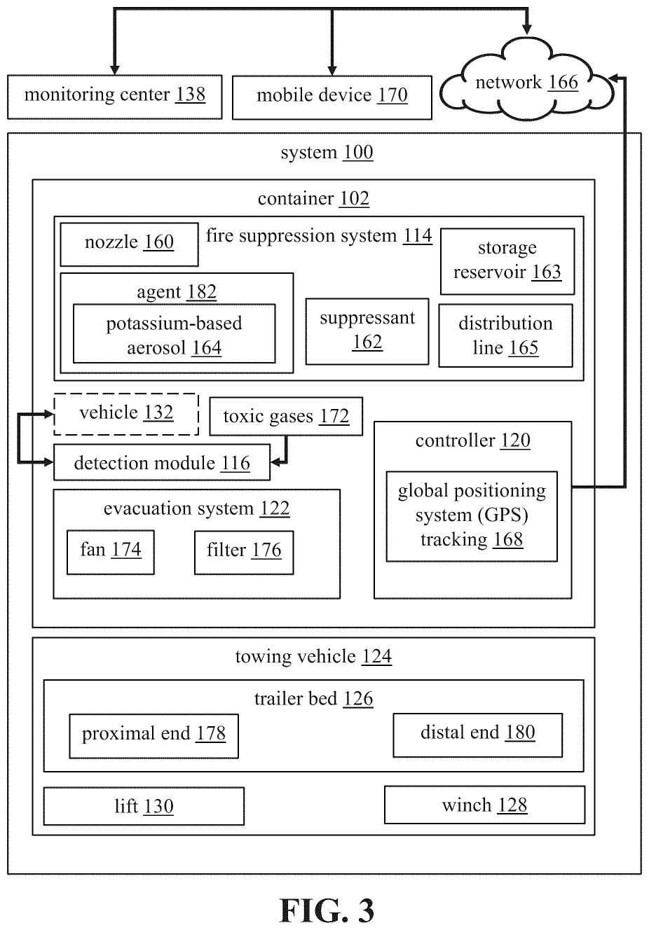

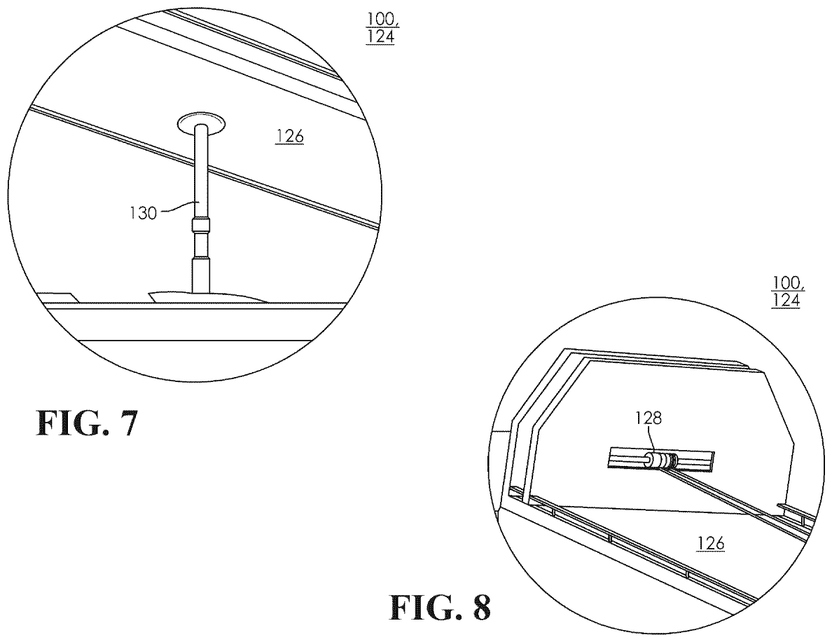

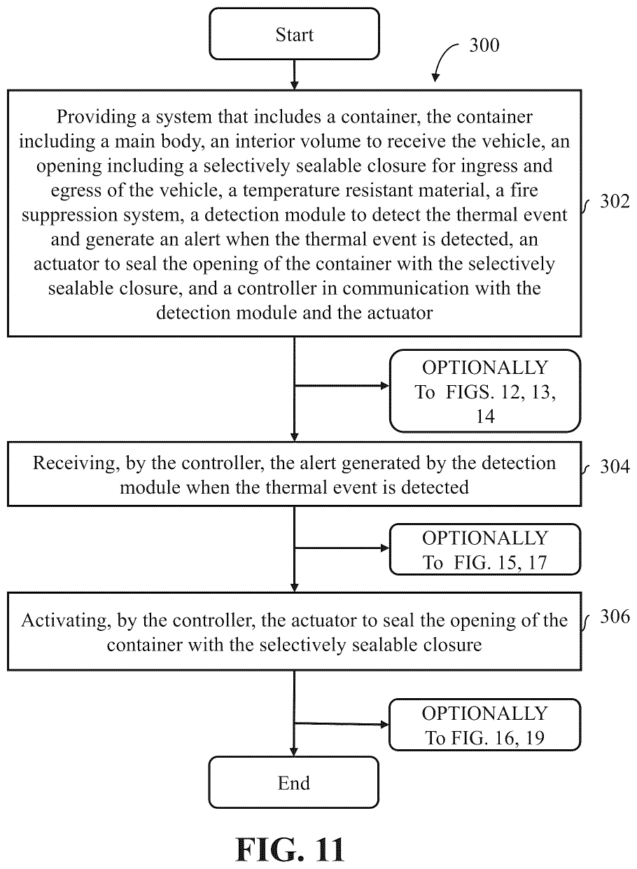

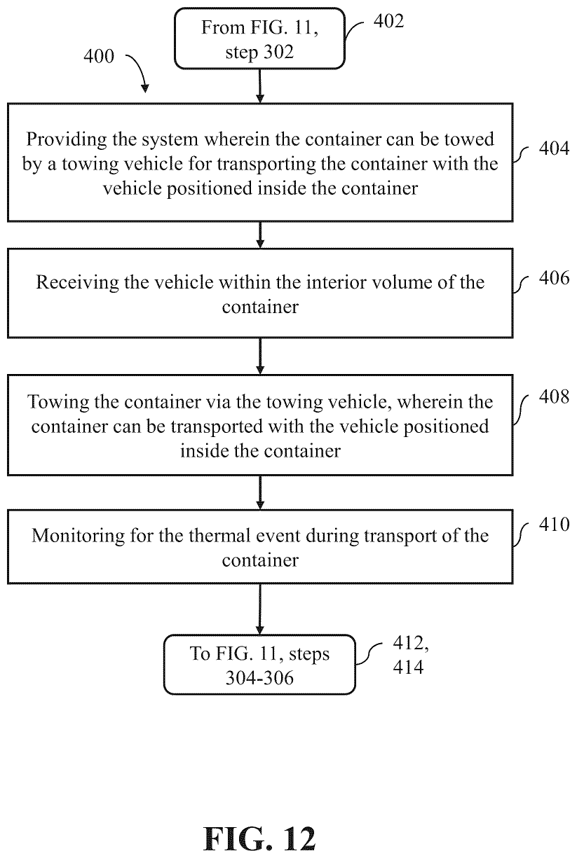

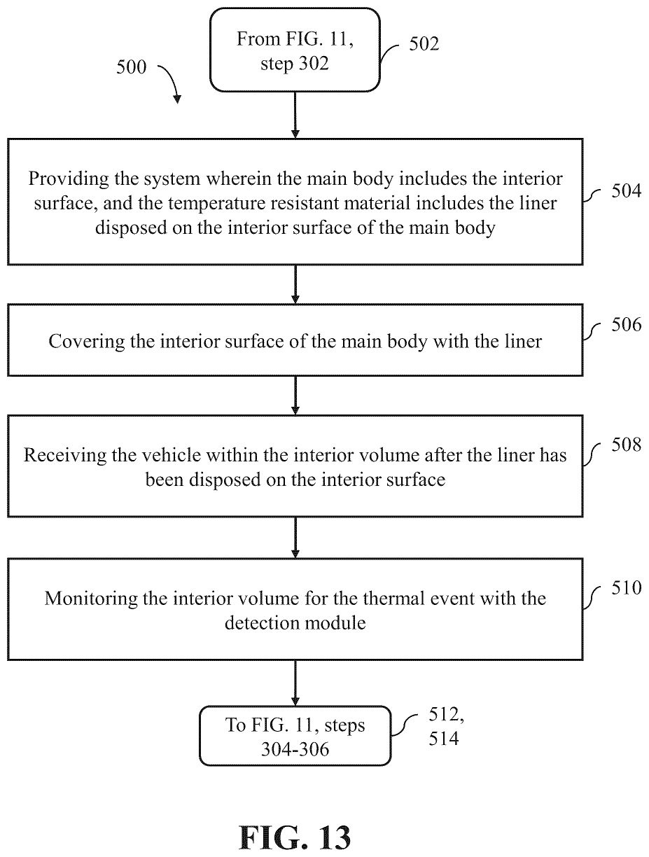

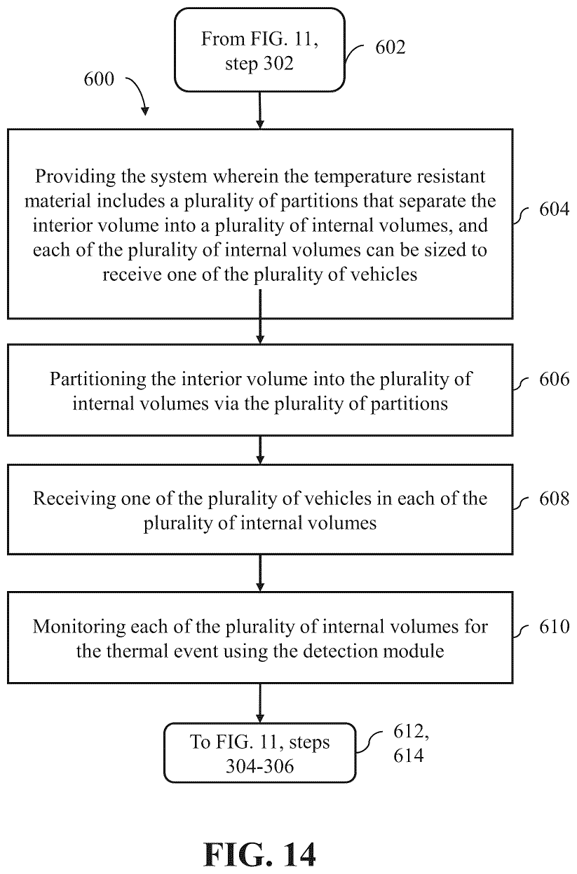

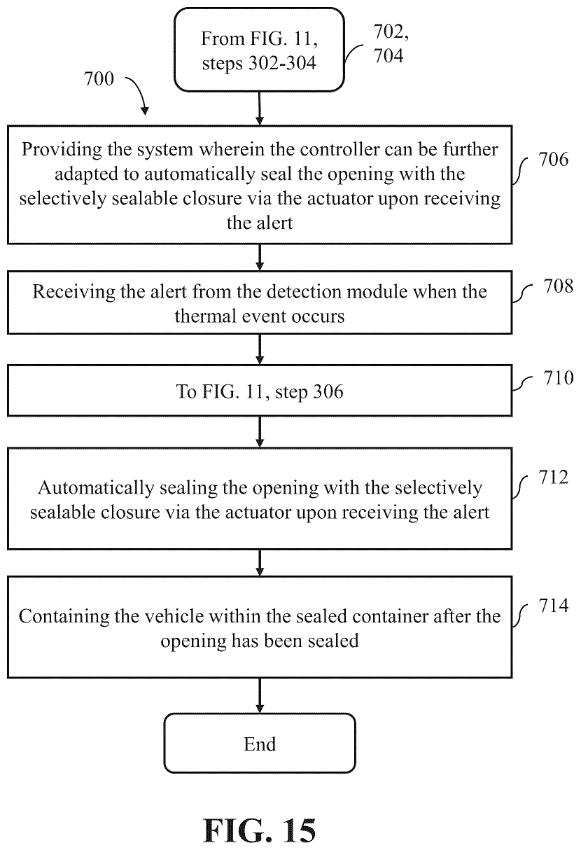

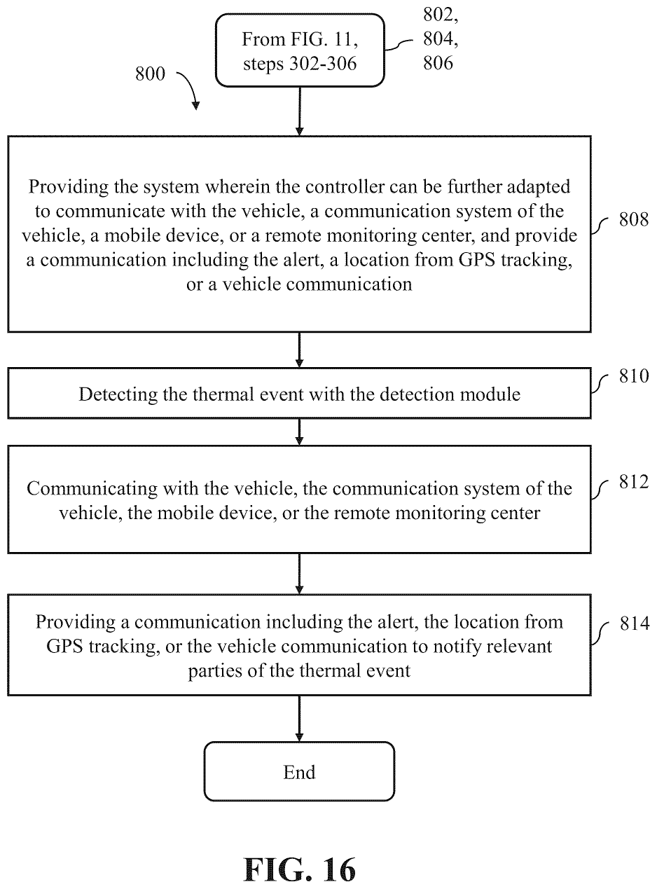

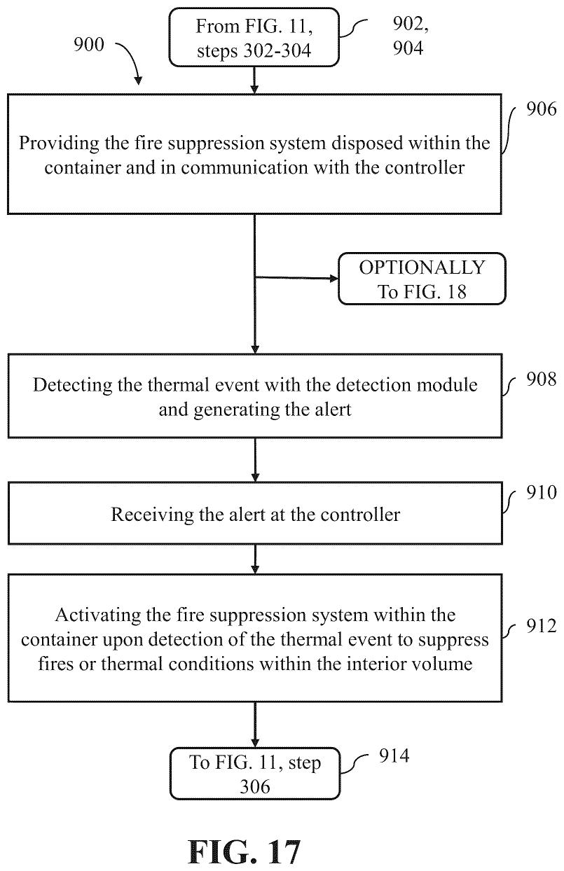

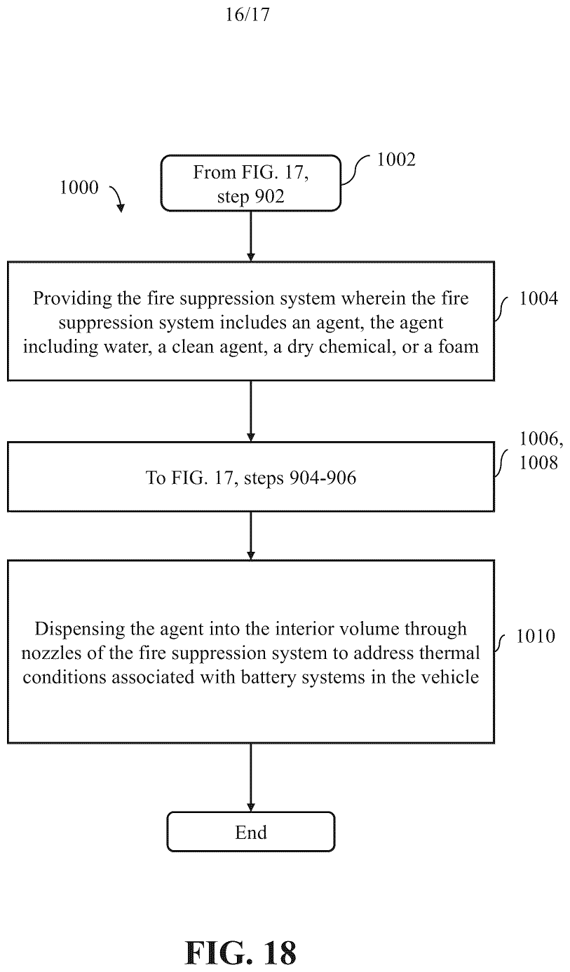

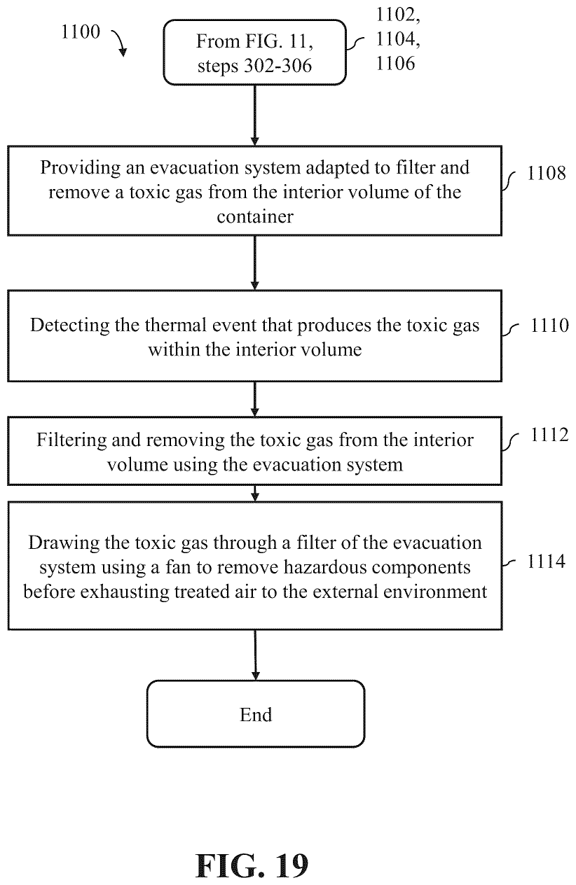

The present technology provides a system 100 and device 200 for containing a vehicle and monitoring for a thermal event, aspects of which are shown generally in accompanying FIGS. 1-10. A method 300 for containing a vehicle during and monitoring for a thermal event is also provided, aspects of which are shown in FIGS. 11A and 11B. A method 400 for containing a vehicle during and monitoring for a thermal event is also provided, aspects of which are shown in FIG. 12. A method 500 for containing a vehicle during and monitoring for a thermal event is provided, aspects of which are shown in FIG. 13. Another method 600 for containing a vehicle during and monitoring for a thermal event is also provided, aspects of which are shown in FIG. 14. Yet another method 700 for containing a vehicle during and monitoring for a thermal event is also provided, aspects of which are shown in FIG. 15. Another method 800 for containing a vehicle during and monitoring for a thermal event is also provided, aspects of which are shown in FIG. 16. Yet another method 900 for containing a vehicle during and monitoring for a thermal event is also provided, aspects of which are shown in FIG. 17. And yet another method 1000 for containing a vehicle during and monitoring for a thermal event is also provided, aspects of which are shown in FIG. 18. And still another method 1100 for containing a vehicle during and monitoring for a thermal event is also provided, aspects of which are shown in FIG. 19.

The system 100, device 200, and methods 300, 400, 500, 600, 700, 800, 900, 1000, and 1100 allow for the containment and monitoring of a vehicle for potential thermal events. As shown in FIGS. 1-10, the system 100 can include a container 102. The container 102 can include a main body 104, an interior volume 106, an opening 108, the opening 108 including a selectively sealable closure 110, a temperature resistant material 112, and fire suppression system 114. The system 100 can include a detection module 116, an actuator 118, a controller 120, and an evacuation system 122. The system 100 can include a towing vehicle 124. The towing vehicle 124 can include a trailer bed 126, a winch 128, and a lift 130.

The container 102 can allow for the containment and shipping of a vehicle 132 and monitor for a thermal event 134. For example, the container 102 can contain a vehicle 132 with a battery that can undergo a thermal event 134, for example, thermal runaway. The container 102 can receive and contain the vehicle 132 within the interior volume 106 while providing protection against thermal events 134 that can occur. The structural components of the container 102 can work together to contain a vehicle 132 that can be damaged or compromised, e.g., experiencing a thermal condition requiring isolation. For example, the container 102 can include active cooling technologies such as forced convection, liquid cooling, refrigeration, or thermoelectric cooling. The container 102 can also include other forms of temperature control, for example, the use of insulation or other internal cooling agents. The container 102 can include various adaptations, for example, an insert a fire hose. The container 102 can include power systems such as a backup battery, a generator, or connection to a utility grid. The container 102 can include emergency buttons on the main body 104 of the container 102, for example, an emergency on or off switch for suppression and alarms.

The container 102 can be transported to a recovery facility 140, a processing center 142, or other location while maintaining adequate containment of the vehicle 132. For example, the container 102 can incorporate transport mechanisms such as wheels, slides, or tracks to facilitate movement of the entirety of the container 102 with the vehicle 132 positioned inside, particularly when a damaged vehicle 132 needs to be loaded or when the container 102 needs to be transported to recovery or processing facilities. Specifically, the container 102 can utilize configurations of transport mechanisms such as fixed wheels, swivel casters, or a combination of both to enable maneuverability during transport and positioning, where these mechanisms can be constructed from durable materials, e.g., heavy-duty steel, reinforced rubber, or polyurethane compounds capable of supporting the combined weight of the container and electric vehicle. It should be appreciated that the container 102 can include other transportation features, e.g., a motor for self-powered transport.

The container 102 can include a visual alarm 144 and an audio alarm 146 to provide local warnings when a thermal event 134 is detected. For example, the visual alarm 144 can include lights or displays that activate when an alert 148 is generated by the detection module 116. The audio alarm 146 can produce sounds to warn nearby personnel of the thermal event 134. Alternatively, the controller 120 can activate both the visual alarm 144 and the audio alarm 146 when the thermal event 134 is detected. These fire suppression system 114 and audio alarm 146 can provide immediate notification to personnel in proximity to the container 102, allow the personnel to maintain safe distances.

The main body 104 of the container 102 can provide the structural framework and enclosure for the interior volume 106. The main body 104 can be constructed from materials suitable for withstanding thermal events 134 and providing structural integrity during transport of the vehicle 132. In other words, the main body 104 can define the overall dimensions and configuration of the container 102, with sizing appropriate to accommodate vehicles 132 such as electric vehicles. For example, the main body 104 can include a rectangular shape, including one or more walls, a floor, and a ceiling that enclose the interior volume 106 on multiple sides. It should be appreciated that the main body 104 can maintain structural integrity even when exposed to elevated temperatures associated with a thermal event 134 occurring within the interior volume 106. The main body 104 can include an interior surface 150 upon which the temperature resistant material 112 can be disposed. It should be understood that the interior surface 150 can encompass the walls, floor, and ceiling that define the interior volume 106.

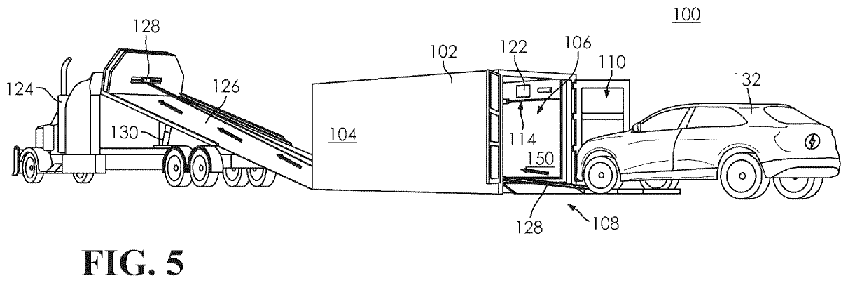

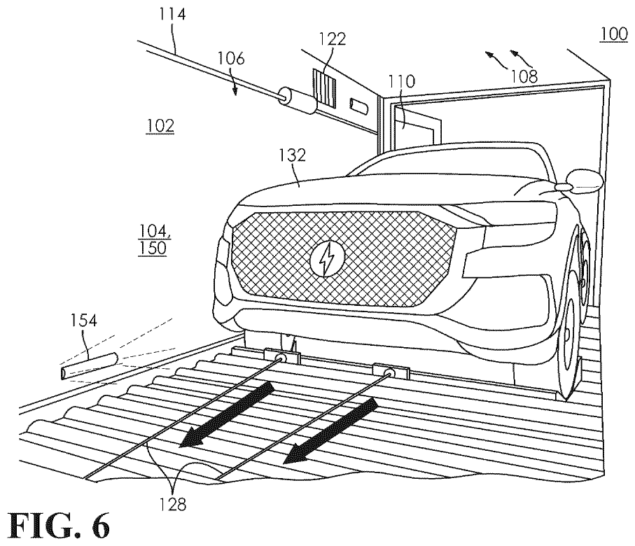

As shown in FIGS. 5 and 6, the interior volume 106 of the container 102 can be sized and shaped to receive the vehicle 132. In other words, the interior volume 106 can provide space for the vehicle 132 to be positioned within the container 102, whether the vehicle 132 can be driven, rolled, or otherwise moved into position. The interior volume 106 can accommodate vehicles 132 of various sizes and configurations, including electric vehicles 132 with batteries. The dimensions of the interior volume 106 can allow for adequate clearance around the vehicle 132 to facilitate ingress and egress while also providing space for a sensor 154, a fire suppression system 114, and other system 100 elements. The interior volume 106 can be monitored by the detection module 116 to identify a thermal event 134 that can develop after the vehicle 132 has been received within the container 102.

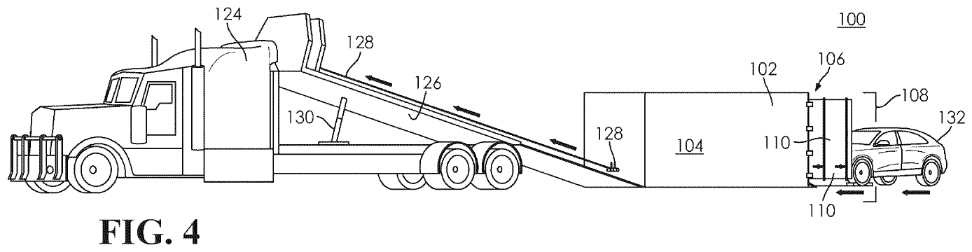

The opening 108 of the container 102 can provide access for ingress and egress of the vehicle 132 into and out of the interior volume 106, as shown in FIGS. 4-6, and 10. The opening 108 can be sized to allow the vehicle 132 to pass through when the opening 108 can be in an unsealed state. The opening 108 can include the selectively sealable closure 110 that can transition between open and closed states to control access to the interior volume 106. The opening 108 can incorporate automated opening and closing mechanisms, e.g., electric motors, hydraulic systems, or pneumatic actuators to facilitate the movement between positions.

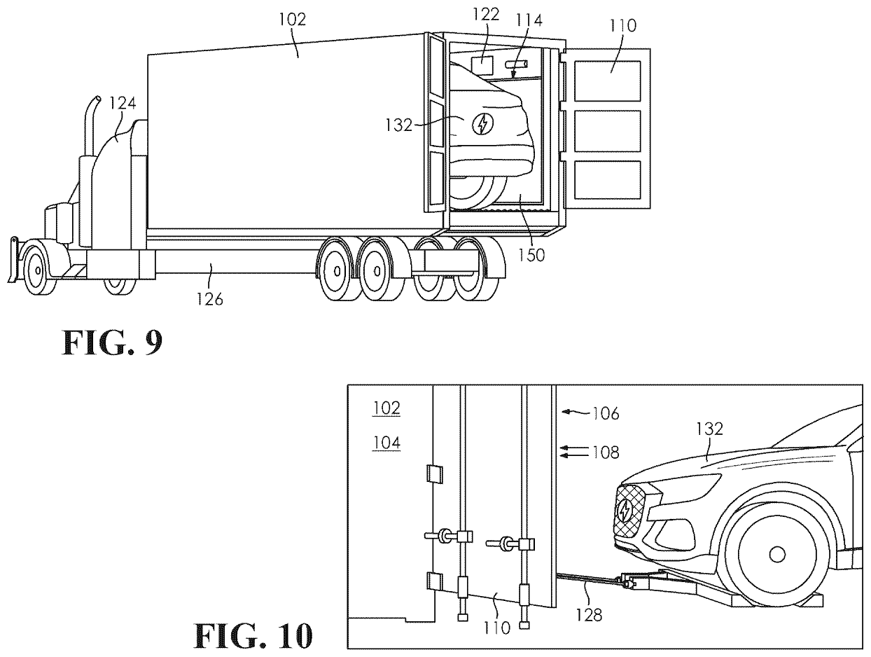

The selectively sealable closure 110, as shown in FIG. 9, can be operated by the actuator 118 to seal the opening 108 when a thermal event 134 is detected, thereby containing the vehicle 132 and any thermal conditions within the interior volume 106. For example, the selectively sealable closure 110 can incorporate a door, ramp, or combination thereof to facilitate movement of the vehicle 132, where the ramp can be adjustable to accommodate different vehicle ground clearances and loading conditions, and can include features such as side rails, guide markers, or integrated lighting for improved visibility during operation. The selectively sealable closure 110 can be constructed from a temperature resistant material 112, for example, ceramic composites, fire-resistant metals, or multi-layered insulated panels. It should be understood that the selectively sealable closure 110 can include safety features such as emergency release mechanisms, reinforced sealing edges, or viewing windows to monitor the interior. For example, the selectively sealable closure 110 can utilize various approaches including compression gaskets, intumescent seals that expand under heat, or multi-point locking systems to ensure proper containment. One of ordinary skill in the art can select other configurations, materials, mechanisms, and sealing systems as desired.

The temperature resistant material 112 can be incorporated into the container 102 to provide protection against thermal events 134. The temperature resistant material 112 can withstand elevated temperatures that can occur during thermal runaway or other thermal events 134 involving the vehicle 132. For example, the temperature resistant material 112 can include fire-rated materials, thermal insulation, or specialized coatings that resist degradation when exposed to heat. The temperature resistant material 112 can help contain thermal energy within the interior volume 106 and prevent damage to external areas surrounding the container 102. The temperature resistant material 112 can be positioned on an interior surface 150 of the main body 104 or incorporated into the structure of the main body 104 itself. For example, the temperature resistant material 112 can include ceramic fibers, aramid fibers, or metal-coated fabrics that can withstand predetermined temperatures associated with undesirable thermal events, for example.

The temperature resistant material 112 can include a liner 152 that can be disposed on the interior surface 150 of the main body 104. The liner 152 can provide a protective layer between the interior surface 150 and the interior volume 106 where the vehicle 132 can be positioned. For example, the liner 152 can be composed of fire-resistant materials, thermal barriers, or multiple layers of protective materials that resist degradation when exposed to thermal events 134. The liner 152 can cover substantially all of the interior surface 150 to provide comprehensive thermal protection throughout the interior volume 106.

The present application further incorporates by reference the entirety of U.S. patent application Ser. No. 18/933,055 titled SMART FIRE BLANKET DEVICE, SYSTEM, AND METHOD filed on Oct. 31, 2024, which discloses temperature resistant materials 112 and configurations for containing a thermal event 134, including multi-layer temperature resistant materials 112 capable of withstanding temperatures up to 1000° C. The temperature resistant material 112 technologies disclosed in this application are relevant to the present material composition for containing a thermal event 134 in an electric vehicle 132.

The temperature resistant material 112 can include one or more partitions 156, for example, one or more partitions 156 can be used to separate the interior volume 106 into multiple internal volumes 158. Each of the internal volumes 158 can be sized and shaped to receive a vehicle 132. The partitions 156 can extend between an interior surface 150 of the main body 104 to divide the interior volume 106 into distinct compartments or sections. In other words, the partitions 156 can be constructed from the temperature resistant material 112 to provide thermal isolation between adjacent internal volumes 158. The partitions 156 can allow the container 102 to simultaneously contain multiple vehicles 132 while providing separation between them. The internal volumes 158 created by the partitions 156 can each be monitored by a sensor 154 to detect a thermal event 134 occurring in an individual internal volume 158. For example, the partitions 156 can include different arrangements such as fixed vertical dividers, removable panels, or adjustable barriers that can be repositioned to accommodate various vehicle sizes and quantities. The partitions 156 can incorporate additional features such as intumescent coatings that expand under heat, fire-resistant seals along partition edges, or integrated ventilation systems to manage air flow between compartments. The connection points between the partitions 156 and the interior surface 150 of the container 102 can utilize various mounting systems, e.g., bolted connections, track-mounted assemblies, or interlocking panel designs that maintain thermal isolation while allowing for maintenance access. It should be appreciated that the partitions 156 can include integrated sensor 154 mounting points, fire suppression system 114 routing channels, or other observation features for monitoring individual compartments. One of ordinary skill in the art can select other materials, configurations, mounting systems, and integrated features as desired.

As shown in FIGS. 1, 3, 5-6, and 9, the fire suppression system 114 can be located within the container 102 and in communication with the controller 120. The fire suppression system 114 can be activated by the controller 120 when a thermal event 134 is detected to suppress fires or thermal conditions within the interior volume 106. The fire suppression system 114 can include a nozzle 160, a suppressant 162, a storage reservoir 163, and a distribution line 165 to deliver the suppressant 162 throughout the interior volume 106. The fire suppression system 114 can be specifically adapted for addressing a thermal event 134 associated with a battery in an electric vehicle 132. It should be appreciated that the fire suppression system 114 can operate automatically upon detection of thermal events 134 to rapidly deploy the suppressant 162 within the interior volume 106.

The fire suppression system 114 can include an agent 182 to extinguish fires, e.g., water, clean agents including gaseous or chemical agents, dry chemicals, or foam. Clean agents can include, for example, inert gases such as argon and helium, hydrofluorocarbons, or carbon dioxide. Dry chemicals can include, for example, powder-based agents, e.g., sodium bicarbonate or mono-ammonium phosphate. Foam-based fire suppression systems 114 can include liquid sprays that create a foam texture. The fire suppression system 114 agent 182 can include wet or dry chemicals. For example, the fire suppression system 114 can include a potassium-based aerosol 164 delivery mechanism, for example, the FirePro™ aerosol fire suppression system manufactured by FirePro Systems Limited. The potassium-based aerosol 164 can be particularly suitable for suppressing fires associated with electric vehicle 132, e.g., thermal runaway conditions within a battery. The fire suppression system 114 can discharge the potassium-based aerosol 164 through the nozzle 160 into the interior volume 106 when activated by the controller 120. The potassium-based aerosol 164 can be stored under pressure or generated on-demand by the fire suppression system 114. The fire suppression system 114 can provide rapid deployment of the potassium-based aerosol 164 to address thermal events 134 before they can escalate or cause damage beyond the interior volume 106.

As shown in FIGS. 1-3, the detection module 116 can provide remote monitoring, via the controller 120, to an emergency responder 136, a remote monitoring center 138, and other relevant parties. The detection module 116 can detect the thermal event 134 and generate an alert 148 when the thermal event 134 can be detected. The detection module 116 can monitor conditions within the interior volume 106 of the container 102 to identify when a thermal event 134 is occurring or developing. The detection module 116 can operate continuously or at regular intervals to assess thermal conditions associated with the vehicle 132. For example, the detection module 116 can communicate with the controller 120 to transmit the alert 148 when detection criteria can be satisfied. The detection module 116 can provide early warning of a thermal event 134, allowing for automated responses before conditions escalate.

The detection module 116 can include one or more sensors 154 disposed within the container 102. The sensors 154 can be positioned at multiple locations within the interior volume 106 to monitor thermal conditions from different perspectives. The sensors 154 can include temperature sensors, smoke detectors, gas detectors, or other sensing devices capable of identifying thermal events 134. The sensors 154 can provide redundancy and comprehensive coverage of the interior volume 106, ensuring that a thermal event 134 is detected regardless of where they can originate relative to the vehicle 132. The sensors 154 can be strategically positioned on walls, ceiling, or floor surfaces of the main body 104 to optimize detection capabilities. Examples of sensor 154 configurations can include thermal imaging sensors that can detect temperature variations across different zones of the vehicle, multi-point temperature sensor arrays positioned strategically to monitor critical areas, or infrared cameras configured to detect heat patterns and thermal signatures. The sensor 154 can incorporate various technologies, e.g., piezoelectric sensors for detecting rapid pressure changes, differential pressure sensors for monitoring pressure gradients, or barometric sensors calibrated to detect subtle atmospheric changes during thermal events.

The detection module 116 can utilize smoke detection capabilities, for example, photoelectric smoke detectors that respond effectively to smoldering conditions, ionization smoke detectors optimized for detecting flaming fires, or dual-sensor systems that combine both technologies for comprehensive detection. The detection module 116 can incorporate sensors 154, for example, to monitor humidity and moisture levels, detect vehicle movement during events, and detect specific chemical signatures associated with a battery-related thermal event 134. It should be understood that the communication between the detection module 116 and controller 120 can be established through redundant pathways, e.g., hardwired connections with temperature-resistant cabling, wireless protocols with encrypted data transmission, or hybrid systems that automatically switch between communication methods to ensure continuous monitoring. One of ordinary skill in the art can select suitable sensor 154 types, detection technologies, and communication protocols as desired.

The present application further incorporates by reference the entirety of U.S. patent application Ser. No. 18/933,347 titled “CONTAINER SENSOR ASSEMBLY, SYSTEM, AND METHOD” filed on Oct. 31, 2024, which discloses sensor packet technology for detecting a thermal event 134, e.g., heat, heat vented rise, smoke, humidity, pressure and tilt detection capabilities. The detection module 116 and related technologies disclosed in this application are particularly relevant to the detection module 116 for the present technology for containing a thermal event 134 in an electric vehicle 132.

The detection module 116 can monitor various thermal conditions associated with the vehicle 132. The detection module 116 can monitor for the thermal event 134, e.g., a thermal runaway in batteries, fires, elevated temperatures, or other thermal conditions requiring containment. For example, the thermal event 134 can produce a toxic gas 172, or other hazardous conditions, e.g., heat or flames, within the interior volume 106. The thermal event 134 can be detected by the sensor 154 based on temperature increases, smoke presence, gas detection, or other indicators. The thermal event 134 can trigger automated responses including sealing of the opening 108 by the actuator 118, activation of the fire suppression system 114, operation of the evacuation system 122, and transmission of an alert 148 through a network 166.

The detection module 116 can generate an alert 148 to indicate that the thermal event 134 has been detected. The alert 148 can be transmitted from the detection module 116 to the controller 120 to trigger automated responses. The alert 148 can include information about the nature, location, or severity of the thermal event 134 based on data from the sensor 154. The alert 148 can initiate a sequence of protective actions including sealing of the opening 108, activation of the fire suppression system 114, or transmission of notifications to external parties. The alert 148 can be generated immediately upon detection of conditions exceeding predetermined thresholds indicative of thermal events 134. It should be understood that the detection module 116 can include a power system, e.g., a rechargeable battery, to be included to power the detection module 116.

The actuator 118 can seal the opening 108 of the container 102 with the selectively sealable closure 110. For example, the actuator 118 can be a motor, hydraulic system, pneumatic system, or other mechanism capable of moving the selectively sealable closure 110 to a closed and sealed position. The actuator 118 can receive commands from the controller 120 to initiate sealing operations. The actuator 118 can operate automatically without requiring manual intervention, enabling rapid containment responses when a thermal event 134 is detected. It should be appreciated that the actuator 118 can provide sufficient force to securely close and seal the opening 108 even under adverse conditions that can exist during thermal events 134.

The controller 120 can be in communication with the detection module 116 and the actuator 118, receiving an alert 148 from the detection module 116 when a thermal event 134 is detected. The controller 120 can activate the actuator 118 to seal the opening 108 of the container 102 in response to receiving the alert 148. For example, the controller 120 can include a memory, and a graphical user interface to coordinate operations of the system 100. It should be understood that the controller 120 can execute programmed logic to determine appropriate responses based on the alert 148 and other system 100 conditions, including automated sealing, fire suppression activation, and transmission of notifications.

The controller 120 can communicate with various external systems and devices to provide information about the thermal event 134 and the status of the vehicle 132, for example, the vehicle 132, a communication system 169 of the vehicle 132, a mobile device 170, or a remote monitoring center 138, and provide a communication including the alert 148, a location from global positioning system (GPS) tracking 168, or a vehicle communication. The controller 120 can include or communicate with the network 166 to transmit an alert 148, location data from a GPS tracking 168, and other information to a remote monitoring center 138, mobile device 170, or the vehicle 132 itself. The controller 120 can provide notifications to an emergency responder 136, facility operator, or monitoring personnel when a thermal event 134 is detected. The controller 120 can transmit information about the location of the container 102 through GPS tracking 168, enabling an emergency responder 136 to locate the container 102 during emergencies. The controller 120 can enable real-time monitoring of the system 100 from remote locations through the network 166. The controller 120 can activate the actuator 118 to seal the opening 108 of the container 102 with the selectively sealable closure 110 includes activating the actuator 118 to seal the opening 108 of the container 102 with the selectively sealable closure 110 upon receiving a command from an emergency responder 136.

As shown in FIGS. 1, 3, 5-6, and 9, the evacuation system 122 can filter and remove a toxic gas 172 from the interior volume 106 of the container 102. The evacuation system 122 can address hazardous gases that can be produced during thermal events 134, particularly those associated with battery failures in electric vehicles 132. The evacuation system 122 can include a fan 174 or blower to draw air and gases from the interior volume 106. The evacuation system 122 can include a filter 176 to remove toxic components from the toxic gas 172 before exhausting treated air to the external environment. The evacuation system 122 can operate continuously or can be activated by the controller 120 when a thermal event 134 is detected.

The evacuation system 122 can provide ventilation and filtering to manage a toxic gas 172 produced during thermal events 134. The fan 174 of the evacuation system 122 can create airflow that draws the toxic gas 172 from the interior volume 106 through the filter 176. For example, the filter 176 can remove particulates, chemical contaminants, or other hazardous components from the toxic gas 172. The evacuation system 122 can discharge filtered air through exhaust ports or vents in the main body 104. The evacuation system 122 can help maintain safer conditions within the interior volume 106 and prevent accumulation of the toxic gas 172 that might otherwise increase pressure or create additional hazards within the container 102.

As shown in FIGS. 1, 3-5, and 9, the towing vehicle 124 can be used for transporting container 102 with vehicle 132 positioned inside container 102. For example, the towing vehicle 124 can be commercial semi-truck, flatbed tow truck, or heavy-duty recovery vehicle. Towing vehicle 124 can include trailer bed 126, winch 128, or lift 130. Towing vehicle 124 can enable safe handling and transport of compromised vehicle 132, e.g., without exposing operators of the towing vehicle 124 or surrounding traffic to risks associated with potential thermal events 134. The towing vehicle 124 can transport the container 102 to a recovery facility 140 or a processing center 142 while maintaining containment of vehicle 132.

The trailer bed 126 can be lifted, e.g., positioned in slanted orientation for the container 102 to slide onto trailer bed 126, as shown in FIGS. 4-5, and 7. Trailer bed 126 can have proximal end 178 near towing vehicle 124 and distal end 180 for loading the container 102. For example, the trailer bed 126 can include a flat upper surface where the proximal end 178 and the distal end 180 allow for the smooth uploading of the container 102.

As shown in FIGS. 5-6, 8, and 10, the winch 128 can be located on proximal end 178 of trailer bed 126. The winch 128 can be made of various materials, for example, steel cable, synthetic rope, or chain. The winch 128 can connect with container 102 to pull container 102 onto trailer bed 126. The winch 128 can include various configurations that incorporate additional hitching mechanisms, e.g., ball hitches, pintle hooks, or fifth-wheel connections, along with safety chains and breakaway systems for secure transport.

Lift 130 can tilt or otherwise reorient the trailer bed 126 so that the container 102 can be pulled onto the trailer bed 126 by the winch 128, as shown in FIGS. 4-5, and 7. The lift 130 can include various types of lifts, such as a hydraulic lift, a pneumatic lift, or an electric lift. For example, the lift 130 can lift the trailer bed 126 to a slanted orientation where the proximal end 178 of trailer bed 126 is elevated and the distal end 180 of trailer bed 126 can be disposed on ground.

As shown in FIGS. 1-10, a device 200 is provided. The device 200 can include a main body 104, an interior volume 106 to receive the vehicle 132, an opening 108 for ingress and egress of the vehicle 132, a temperature resistant material 112, and a fire suppression system 114. The opening 108 can include a selectively sealable closure 110. The device 200 can include a detection module 116 to detect a thermal event 134 and generate an alert 148 when the thermal event 134 is detected. The device 200 can include an actuator 118 to seal the opening 108 of the container 102 with the selectively sealable closure 110. The device 200 can include a controller 120 in communication with the detection module 116 and the actuator 118. The controller 120 can receive the alert 148 from the detection module 116 and activate the actuator 118 to seal the opening 108 of the container 102.

As shown in FIG. 11, a method 300 for containing a vehicle 132 during and monitoring for a thermal event 134 is provided. The method 300 can include a step 302 of providing a system 100 that includes a container 102. The container 102 can include a main body 104, an interior volume 106 to receive the vehicle 132, an opening 108 for ingress and egress of the vehicle 132, a temperature resistant material 112, and a fire suppression system 114. The opening 108 can include a selectively sealable closure 110. The system 100 can include a detection module 116 to detect the thermal event 134 and generate an alert 148 when the thermal event 134 is detected. The system 100 can include an actuator 118 to seal the opening 108 of the container 102 with the selectively sealable closure 110. The system 100 can include a controller 120 in communication with the detection module 116 and the actuator 118. The controller 120 can receive the alert 148 from the detection module 116 and activate the actuator 118 to seal the opening 108 of the container 102. The method 300 can include a step 304 of receiving, by the controller 120, the alert 148 generated by the detection module 116 when the thermal event 134 is detected. The method 300 can include a step 306 of activating, by the controller 120, the actuator 118 to seal the opening 108 of the container 102 with the selectively sealable closure 110.

As shown in FIG. 12, a method 400 for transporting a container 102 with a vehicle 132 positioned inside can be provided. The method 400 can include step 302 of method 300 (as step 402 respectively). The method 400 can include a step 404 of providing the system 100 wherein the container 102 can be towed by a towing vehicle for transporting the container 102 with the vehicle 132 positioned inside the container 102. The method 400 can include a step 406 of receiving the vehicle 132 within the interior volume 106 of the container 102. The method 400 can include a step 408 of towing the container 102 via the towing vehicle, wherein the container 102 can be transported with the vehicle 132 positioned inside the container 102. The method 400 can include a step 410 of monitoring for the thermal event 134 during transport of the container 102. The method 400 can include steps 304-306 of method 300 (as steps 412-414 respectively).

As shown in FIG. 13, a method 500 for covering an interior surface 150 of a container 102 with a liner 152 can be provided. The method 500 can include step 302 of method 300 (as step 502 respectively). The method 500 can include a step 504 of providing the system 100 wherein the main body 104 includes the interior surface 150, and the temperature resistant material 112 includes the liner 152 disposed on the interior surface 150 of the main body 104. The method 500 can include a step 506 of covering the interior surface 150 of the main body 104 with the liner 152. The method 500 can include a step 508 of receiving the vehicle 132 within the interior volume 106 after the liner 152 has been disposed on the interior surface 150. The method 500 can include a step 510 of monitoring the interior volume 106 for the thermal event 134 with the detection module 116. The method 500 can include steps 304-306 of method 300 (as steps 512-514 respectively).

As shown in FIG. 14, a method 600 for partitioning an interior volume 106 and receiving one or more vehicles 132 can be provided. The method 600 can include step 302 of method 300 (as step 602 respectively). The method 600 can include a step 604 of providing the system 100 wherein the temperature resistant material 112 includes one or more partitions 156 that separate the interior volume 106 into multiple internal volumes 158, and each of the internal volumes 158 can be sized to receive one of the vehicles 132. The method 600 can include a step 606 of partitioning the interior volume 106 into one or more internal volumes 158 using the partitions 156. The method 600 can include a step 608 of receiving one of the vehicles 132 in each of the internal volumes 158. The method 600 can include a step 610 of monitoring each of the internal volumes 158 for the thermal event 134 using the detection module 116. The method 600 can include steps 304-306 of method 300 (as steps 612-614 respectively).

As shown in FIG. 15, a method 700 for automatically sealing an opening 108 upon receiving an alert 148 can be provided. The method 700 can include steps 302-304 of method 300 (as steps 702-704 respectively). The method 700 can include a step 706 of providing the system 100 wherein the controller 120 can be further adapted to automatically seal the opening 108 with the selectively sealable closure 110 via the actuator 118 upon receiving the alert 148. The method 700 can include a step 708 of receiving the alert 148 from the detection module 116 when the thermal event 134 occurs. The method 700 can include step 306 of method 300 (as step 710 respectively). The method 700 can include a step 712 of automatically sealing the opening 108 with the selectively sealable closure 110 via the actuator 118 upon receiving the alert 148. The method 700 can include a step 714 of containing the vehicle 132 sealed within the container 102 after the opening 108 has been sealed.

As shown in FIG. 16, a method 800 for communicating with external systems and providing communications can be provided. The method 800 can include steps 302-306 of method 300 (as steps 802-806 respectively). The method 800 can include a step 808 of providing the system 100 wherein the controller 120 can be further adapted to communicate with the vehicle 132, a communication system 169 of the vehicle 132, a mobile device 170, or a remote monitoring center 138, and provide a communication including the alert 148, a location from global positioning system (GPS) tracking 168, or a vehicle communication. The method 800 can include a step 810 of detecting the thermal event 134 with the detection module 116. The method 800 can include a step 812 of communicating with the vehicle 132, the communication system 169 of the vehicle 132, the mobile device 170, or the remote monitoring center 138. The method 800 can include a step 814 of providing a communication including the alert 148, the location from GPS tracking 168, or the vehicle communication to notify relevant parties of the thermal event 134.

As shown in FIG. 17, a method 900 for activating a fire suppression system 114 upon detection of a thermal event 134 can be provided. The method 900 can include steps 302-304 of method 300 (as steps 902-904 respectively). The method 900 can include a step 906 of providing the fire suppression system 114 disposed within the container 102 and in communication with the controller 120. The method 900 can include a step 908 of detecting the thermal event 134 with the detection module 116 and generating the alert 148. The method 900 can include a step 910 of receiving the alert 148 at the controller 120. The method 900 can include a step 912 of activating the fire suppression system 114 within the container 102 upon detection of the thermal event 134 to suppress fires or thermal conditions within the interior volume 106. The method 900 can include step 306 of method 300 (as step 914 respectively).

As shown in FIG. 18, a method 1000 for dispensing a fire suppression system 114 agent 182 into an interior volume 106 can be provided. The method 1000 can include step 902 of method 900 (as step 1002 respectively). The method 1000 can include a step 1004 of providing the fire suppression system 114 wherein the fire suppression system 114 includes water, a clean agent, a dry chemical, or a foam. The method 1000 can include steps 904-906 of method 900 (as steps 1006-1008 respectively). The method 1000 can include a step 1010 of dispensing the agent 182 into the interior volume 106 through the nozzle 160 of the fire suppression system 114 to address thermal conditions associated with batteries in the vehicle 132.

As shown in FIG. 19, a method 1100 for filtering and removing a toxic gas 172 from an interior volume 106 can be provided. The method 1100 can include steps 302-306 of method 300 (as steps 1102-1106 respectively). The method 1100 can include a step 1108 of providing an evacuation system 122 adapted to filter and remove a toxic gas 172 from the interior volume 106 of the container 102. The method 1100 can include a step 1110 of detecting the thermal event 134 that produces the toxic gas 172 within the interior volume 106. The method 1100 can include a step 1112 of filtering and removing the toxic gas 172 from the interior volume 106 using the evacuation system 122. The method 1100 can include a step 1114 of drawing the toxic gas 172 through a filter 176 of the evacuation system 122 using a fan 174 to remove hazardous components before exhausting treated air to the external environment.

The present technology can advantageously address the challenges of handling electric vehicles 132 experiencing or at risk of a thermal event 134 through integrated containment, monitoring, and response mechanisms that allow for safe processing without requiring personnel to manually approach compromised vehicles 132. The automated detection and sealing mechanisms of the present technology can provide enhanced safety to emergency responders 136 and transportation providers to handle damaged vehicles 132 by militating against the need for direct manual intervention during a thermal event 134. The temperature resistant material 112 and the fire suppression system 114 can enable safe transport of compromised vehicles 132 that containment and towing services otherwise refuse due to liability concerns. Through these integrated features, the present technology can facilitate the safe handling, transport, and processing of electric vehicles 132 following accidents, fires, or other damage, addressing scenarios such as those encountered during wildfire events where emergency responders 136 have been unable to approach and remove affected vehicles 132.

### EXAMPLES

Example embodiments of the present technology are provided with reference to the several figures enclosed herewith.

### Example 1: Emergency Response to Wildfire-Damaged Electric Vehicles

A wildfire event occurs in California where multiple electric vehicles 132 can be damaged or burned, triggering a thermal event 134 that an emergency responder 136 needs to address. The damaged vehicles 132 can experience repeated thermal events 134 as battery cells undergo thermal runaway, releasing a toxic gas 172 and producing elevated temperatures. Fire department personnel can be reluctant to approach the vehicles 132 due to safety concerns about ongoing thermal events 134 and the unpredictable nature of battery failures. The system 100 can be deployed to the scene to enable safe containment and removal of the compromised vehicles 132 without requiring emergency responders 136 to directly approach the thermal events 134.

The container 102 can be transported to the location of a damaged vehicle 132 and positioned near the vehicle 132 so that the vehicle 132 can enter the main body 104, as shown in FIG. 5. The opening 108 of the container 102 can be accessed, and the selectively sealable closure 110 can be moved to an open position to allow ingress of the vehicle 132. As shown in FIG. 6, the damaged vehicle 132 can then be pulled into the interior volume 106 using rollers at the bottom of the container 102, eliminating the need for personnel to manually push or carry the vehicle 132. Once the vehicle 132 can be positioned within the interior volume 106, the detection module 116 can begin monitoring conditions within the container 102 using one or more sensors 154.

The sensor 154 of the detection module 116 can detect elevated temperatures associated with the thermal event 134 occurring within the vehicle 132. The detection module 116 can generate the alert 148 and transmit it to the controller 120, indicating that the thermal event 134 has been identified. The controller 120 can receive the alert 148 and activate the actuator 118 to seal the opening 108 with the selectively sealable closure 110, thereby containing the vehicle 132 and the thermal event 134 within the interior volume 106. The temperature resistant material 112, including the liner 152 on the interior surface 150, can provide protection against the thermal energy being released by the thermal event 134.

The controller 120 can activate the fire suppression system 114 in response to the alert 148 from the detection module 116. The fire suppression system 114 can discharge the potassium-based aerosol 164 through the nozzle 160 positioned within the interior volume 106 to suppress the thermal event 134. The evacuation system 122 can be activated to filter and remove a toxic gas 172 produced by the thermal event 134, with the fan 174 drawing the toxic gas 172 through the filter 176 before exhausting treated air. The controller 120 can communicate through the network 166 to transmit the alert 148 and GPS tracking 168 information to the remote monitoring center 138, notifying personnel of the thermal event 134 and the location of the container 102.

The container 102 with the sealed vehicle 132 inside can be transported away from the wildfire area to a recovery facility 140 or processing center. The detection module 116 can continue monitoring the interior volume 106 during transport to identify any additional thermal events 134 that can develop. An emergency responder 136 can safely clear the area where the damaged vehicle 132 was located without needing to maintain extended perimeters or evacuation zones. The system 100 can enable multiple damaged vehicles 132 from the wildfire to be safely contained and transported, addressing scenarios where tow truck companies refuse to handle compromised electric vehicles 132 due to liability concerns about thermal events 134 occurring during transit.

### Example 2: Towing and Transportation of Accident-Damaged Vehicle

An electric vehicle 132 involved in a traffic accident has suffered damage to a battery, creating a risk of thermal events 134 during recovery and transport operations. A towing service is contacted to remove the damaged vehicle 132 from the roadway, but the towing company expresses reluctance to transport the vehicle 132 on a conventional tow truck due to concerns that thermal events 134 could damage the tow truck or create hazards during transit. The system 100 can be provided to allow the towing service to safely handle and transport the compromised vehicle 132 without exposing the tow truck or surrounding traffic to risks associated with potential thermal events 134, as shown in FIGS. 4-5, and 9. The container 102 can be towed by a towing vehicle 124 to the accident scene, where the damaged vehicle 132 can be received within the interior volume 106, as shown in FIGS. 6 and 10.

The opening 108 of the container 102 can be accessed at the accident scene, allowing the damaged vehicle 132 to enter the interior volume 106. The vehicle 132 can be rolled or pulled into the container 102 using the opening 108, as shown in FIG. 6, and for example, a ramp to facilitate movement of the damaged vehicle 132. Once the vehicle 132 can be positioned within the interior volume 106, the detection module 116 can begin monitoring for thermal events 134 using the sensors 154 distributed throughout the container 102. The controller 120 can be placed in an active monitoring mode, ready to receive the alert 148 from the detection module 116 if thermal conditions exceeding predetermined thresholds can be detected.

During transport of the container 102 along roadways to a recovery facility 140, the sensor 154 can continuously monitor conditions within the interior volume 106 where the vehicle 132 can be positioned. The detection module 116 can detect an increase in temperature indicating that a thermal event 134 is developing within the a battery of the vehicle 132. The detection module 116 can generate the alert 148 and transmit it to the controller 120, triggering automated containment responses. The controller 120 can activate the actuator 118 to seal the opening 108 with the selectively sealable closure 110, ensuring that the thermal event 134 remains contained within the interior volume 106 protected by the temperature resistant material 112.

The controller 120 can activate the fire suppression system 114 to address the developing thermal event 134 sealed within the container 102. The potassium-based aerosol 164 can be discharged through the nozzle 160 into the interior volume 106 to suppress the thermal event 134 before conditions can escalate. The evacuation system 122 can be activated to manage a toxic gas 172 that can be produced by the thermal event 134, with the fan 174 drawing the toxic gas 172 through the filter 176. The visual alarm 144 and audio alarm 146 on the container 102 can be activated to alert 148 the driver of the towing vehicle 124 and surrounding vehicles that a thermal event 134 has been detected and containment measures have been initiated.

The controller 120 can transmit the alert 148, GPS tracking 168 information, and status updates to the mobile device 170 of the tow truck driver and to the remote monitoring center 138. The tow truck driver can be notified through the mobile device 170 that the thermal event 134 has been detected and that automated containment and suppression measures have been activated. The driver can continue transporting the container 102 to the recovery facility 140, with confidence that the thermal event 134 can be sealed within the container 102 protected by the temperature resistant material 112. The system 100 can enable towing companies to safely transport damaged electric vehicles 132 that they might otherwise refuse to handle, addressing concerns about thermal events 134 occurring during transit and potentially damaging tow trucks or creating roadway hazards.

### Example 3: Processing Facility Receiving Multiple Vehicles

A vehicle recycling facility or battery processing center can receive multiple electric vehicles 132 that can be at risk of thermal events 134 due to damage, battery failures, or degradation. The facility needs to store the vehicles 132 for periods of time before they can be processed, creating safety concerns about thermal events 134 developing while the vehicles 132 are on the premises. The system 100 can be provided with one or more partitions 156 that separate the interior volume 106 into one or more internal volumes 158, with each internal volume 158 sized to receive one vehicle 132. The container 102 with the partitions 156 can enable the facility to simultaneously contain multiple vehicles 132 while providing thermal isolation between adjacent internal volumes 158 through the temperature resistant material 112.

Multiple vehicles 132 can be received within the container 102, with each vehicle 132 positioned in a separate one of the internal volumes 158 created by the partitions 156. The detection module 116 can include a sensor 154 positioned in each of the internal volumes 158 to independently monitor conditions associated with each of the vehicles 132. The controller 120 can receive data from the sensor 154 in all of the internal volumes 158, enabling simultaneous monitoring of multiple vehicles 132 for thermal events 134. The interior surface 150 of each internal volume 158 can be covered with the liner 152 to provide temperature resistant protection specific to each compartment where the vehicles 132 can be positioned.

The sensor 154 monitoring one of the internal volumes 158 can detect a thermal event 134 beginning to develop in one of the vehicles 132 stored within that internal volume 158. The detection module 116 can generate the alert 148 specific to the internal volume 158 where the thermal event 134 has been detected and transmit the alert 148 to the controller 120. The controller 120 can identify which of the internal volumes 158 can be experiencing the thermal event 134 based on the sensor 154 that generated the alert 148. The partitions 156 can provide thermal separation between the internal volume 158 experiencing the thermal event 134 and the adjacent internal volumes 158 containing other vehicles 132, helping to isolate the thermal conditions.

The controller 120 can activate the fire suppression system 114 to deliver the agent 182, e.g., the potassium-based aerosol 164 specifically into the internal volume 158 where the thermal event 134 has been detected. The nozzle 160 positioned within that internal volume 158 can discharge the potassium-based aerosol 164 to suppress the thermal event 134 in the affected vehicle 132. The evacuation system 122 can be activated to filter and remove a toxic gas 172 produced by the thermal event 134, with the fan 174 drawing the toxic gas 172 from the affected internal volume 158 through the filter 176. The controller 120 can transmit the alert 148 through the network 166 to facility operators at the remote monitoring center 138, notifying them which vehicle 132 in which internal volume 158 can be experiencing the thermal event 134.

Facility personnel can receive the alert 148 through the remote monitoring center 138 without needing to be physically present near the container 102 or conduct manual inspections that might expose them to hazardous conditions. The GPS tracking 168 capabilities can enable a facility operator to identify the specific location of the container 102 on the facility premises. The other vehicles 132 in the adjacent internal volumes 158 can continue to be monitored by the detection module 116 while the thermal event 134 in the one internal volume 158 can be addressed by the fire suppression system 114 and evacuation system 122. Advantageously, the system 100 can enable the processing facility to safely receive, store, and monitor multiple electric vehicles 132 that can be at risk of thermal events 134, addressing scenarios where facilities might otherwise lack adequate containment for processing compromised vehicles 132.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for containing a vehicle and monitoring for a thermal event, comprising:
a container including:
a main body,
an interior volume to receive the vehicle,
an opening for ingress and egress of the vehicle, the opening including a selectively sealable closure, and
a temperature resistant material;
a detection module configured to detect the thermal event and generate an alert when the thermal event is detected;
an actuator configured to seal the opening of the container with the selectively sealable closure; and
a controller in communication with the detection module and the actuator, the controller configured to receive the alert from the detection module and activate the actuator to seal the opening of the container with the selectively sealable closure.

2. The system of claim 1, wherein the container is configured to be towed by a towing vehicle for transporting the container with the vehicle received within the interior volume of the container.

3. The system of claim 1, wherein the main body includes an interior surface, and the temperature resistant material includes a liner disposed on the interior surface of the main body.

4. The system of claim 1, wherein the temperature resistant material includes a plurality of partitions that separate the interior volume into a plurality of internal volumes, wherein each of the internal volumes is configured to receive one of a plurality of vehicles.

5. The system of claim 1, wherein the detection module includes a plurality of sensors disposed within the container.

6. The system of claim 1, wherein the controller is further configured to:
communicate with a member selected from a group consisting of the vehicle, a communication system of the vehicle, a mobile device, a remote monitoring center, and combinations thereof; and
provide a communication including a member selected from a group consisting of the alert, a location, a vehicle communication, and combinations thereof.

7. The system of claim 1, wherein the controller is further configured to automatically activate the actuator to seal the opening of the container with the selectively sealable closure upon receiving the alert from the detection module when the thermal event occurs.

8. The system of claim 1, further comprising a fire suppression system disposed within the container and in communication with the controller.

9. The system of claim 8, wherein the fire suppression system includes an agent selected from a group consisting of water, a clean agent, a dry chemical, a foam, and combinations thereof.

10. The system of claim 1, further comprising an evacuation system configured to filter and remove a toxic gas from the interior volume of the container, the evacuation system in communication with the controller.

11. A method of containing a vehicle and monitoring for a thermal event, comprising:
providing a system for containing a vehicle and monitoring for a thermal event, the system including:
a container including:
a main body,
an interior volume to receive the vehicle,
an opening for ingress and egress of the vehicle, the opening including a selectively sealable closure,
a temperature resistant material;
a detection module configured detect the thermal event and generate an alert when the thermal event is detected;
an actuator configured to seal the opening of the container with the selectively sealable closure; and
a controller in communication with the detection module and the actuator, the controller configured to receive the alert from the detection module and activate the actuator to seal the opening of the container;
receiving the vehicle within the interior volume of the container;
detecting, by the detection module, the thermal event and generating the alert when the thermal event is detected;
receiving, by the controller, the alert generated by the detection module when the thermal event is detected; and
activating, by the controller, the actuator to seal the opening of the container with the selectively sealable closure when the alert is received by the controller.

12. The method of claim 11, wherein:
the container is configured to be towed by a towing vehicle for transporting the container with the vehicle positioned inside the container; and
the method further comprises:
towing the container via the towing vehicle, the container being transported with the vehicle positioned inside the container.

13. The method of claim 11, wherein the main body includes an interior surface, and the temperature resistant material includes a liner disposed on the interior surface of the main body.

14. The method of claim 13, wherein the temperature resistant material includes a plurality of partitions that separate the interior volume into a plurality of internal volumes, and each of the plurality of internal volumes are configured to receive one of a plurality of vehicles.

15. The method of claim 11, wherein activating, by the controller, the actuator to seal the opening of the container with the selectively sealable closure includes activating the actuator to seal the opening of the container with the selectively sealable closure upon receiving a command from an emergency responder.

16. The method of claim 11, wherein:
the controller is further configured to communicate with a member selected from a group consisting of the vehicle, a communication system of the vehicle, a mobile device, a remote monitoring center, and combinations thereof, and provide a communication including a member selected from a group consisting of the alert, a location, a vehicle communication, and combinations thereof; and
the method further comprises:
communicating with the member selected from the group consisting of the vehicle, the communication system of the vehicle, the mobile device, the remote monitoring center, and combinations thereof; and
providing the communication including the member selected from the group consisting of the alert, the location, the vehicle communication, and combinations thereof.

17. The method of claim 11, wherein:
the system further comprises a fire suppression system disposed within the container and in communication with the controller; and
the method further comprises:
activating, by the controller, the fire suppression system within the container when the controller receives the alert from the detection module.

18. The method of claim 17, wherein the fire suppression system includes an agent selected from a group consisting of water, a clean agent, a dry chemical, a foam, and combinations thereof.

19. The method of claim 11, wherein:
the system further comprises an evacuation system configured to filter and remove a toxic gas from the interior volume of the container, the evacuation system in communication with the controller; and
the method further comprises:
activating, by the controller, the evacuation system to filter and remove the toxic gas from the interior volume of the container when the controller receives the alert from the detection module.

20. A system for containing a vehicle and monitoring for a thermal event, comprising:
a container including:
a main body,
an interior volume to receive the vehicle,
an opening for ingress and egress of the vehicle, the opening including a selectively sealable closure, and
a temperature resistant material;
a detection module configured to detect the thermal event and generate an alert when the thermal event is detected;
an actuator configured to seal the opening of the container with the selectively sealable closure; and
a controller in communication with the detection module and the actuator, the controller configured to receive the alert from the detection module and activate the actuator to seal the opening of the container with the selectively sealable closure;
wherein:
the container is configured to be towed by a towing vehicle for transporting the container with the vehicle received within the interior volume of the container;
the main body includes an interior surface, and the temperature resistant material includes a liner disposed on the interior surface of the main body;
the temperature resistant material includes a plurality of partitions that separate the interior volume into a plurality of internal volumes, wherein each of the internal volumes is configured to receive one of a plurality of vehicles;
the detection module includes a plurality of sensors disposed within the container;
the controller is further configured to communicate with a member selected from a group consisting of the vehicle, a communication system of the vehicle, a mobile device, a remote monitoring center, and combinations thereof, and provide a communication including a member selected from a group consisting of the alert, a location, a vehicle communication, and combinations thereof;
the controller is further configured to automatically activate the actuator to seal the opening of the container with the selectively sealable closure upon receiving the alert from the detection module when the thermal event occurs;
the system further comprises a fire suppression system disposed within the container and in communication with the controller;
the fire suppression system includes an agent selected from a group consisting of water, a clean agent, a dry chemical, a foam, and combinations thereof; and
the system further comprises an evacuation system configured to filter and remove a toxic gas from the interior volume of the container, the evacuation system in communication with the controller.
